(19) United States
(12) Patent Application Publication
(10) Pub. No.: US 2026/0363266 A1
(43) Pub. Date: Nov. 19, 2026

(54) MICROSCOPIC PHYSICAL TEXTURES FOR CONFECTIONS

(71) Applicant: Disney Enterprises, Inc., Burbank, CA (US)

(72) Inventors: Daniel JOSEPH, Windermere, FL (US); Miles MALINE, Orlando, FL (US); Jessica KLOUDA, Winter Garden, FL (US); Jason William MONAHAN, Celebration, FL (US)

(73) Assignee: Disney Enterprises, Inc., Burbank, CA (US)

(21) Appl. No.: 19/207,051

(22) Filed: May 13, 2025

(51) Int. Cl. A23G 3/54; A23G 3/34

(52) U.S. Cl. CPC A23G 3/54; A23G 3/007

(57) ABSTRACT

Systems and methods described herein relate to a confection. The confection includes microscopic physical textures on a surface of the confection. The microscopic physical textures encode a hologram. The microscopic physical textures are configured to interact with light to form an image based on the encoded hologram.

### TECHNICAL FIELD

The present disclosure relates generally to microscopic physical textures for confections. Particularly, the use of molding microscopic physical textures onto confections, such as candies and chocolates.

### Background

In confectionery technologies, to create imagery on a confection, an image is generally printed on the confection. Additionally, the confection may be molded to have a shape and/or texture of a desired image. However, the image molded on the confection is stationary. In other words, the confection does not appear to change color or animate. Confections may have inedible appliques or packaging that appear to change color, but the edible confections are not perceived to include movement, such as animations and color changes.

### SUMMARY

Various embodiments relate to a confection. The confection includes microscopic physical textures on a surface of the confection. The microscopic physical textures encode a hologram. The microscopic physical textures are configured to interact with light to form an image based on the encoded hologram.

In various embodiments, the formed image includes at least one of color, movement, or a change in a shape. In various embodiments, the confection is a sugar glass, a chocolate, or a gummy candy. In various embodiments, the encoded hologram is a representation of an object or a character. In various embodiments, the object or the character is perceived to be in a first position relative to the surface at a first view of the confection and the object or the character is perceived to be in a second position relative to the surface at a second view of the confection. In various embodiments, the first position is different than the second position. In various embodiments, the surface is an external surface of the confection. In various embodiments, the confection includes second microscopic physical textures encoding a second hologram on a second surface of the confection. The second microscopic physical textures are configured to interact with the light to form a second image based on the second encoded hologram. In various embodiments, the surface of the confection has a glossy appearance. In various embodiments, the surface of the confection is three-dimensional. In various embodiments, the light on the microscopic physical textures is controlled by controlling a movement or an intensity of the light.

Various embodiments relate to a mold for use on a confection. The mold includes a surface having mold microscopic textures formed by a holographic material including microscopic physical textures. The mold microscopic textures correspond to the microscopic physical textures. The mold is configured to apply the microscopic physical textures from the holographic material to the confection.

In various embodiments, the mold is configured to be stamped on the confection. In various embodiments, the mold microscopic textures are formed through a needle configured to scratch the surface of the mold. In various embodiments, the mold microscopic textures correspond to a negative or of the microscopic physical textures.

Various embodiments relate to a method for producing a confection. The method includes applying a mold to the confection and forming microscopic physical textures on a surface of the confection. The microscopic physical textures encode a hologram such that interaction of light with the microscopic physical textures allow for perception of an image associated with the confection.

In various embodiments, the method further includes before applying the mold to the confection, creating the mold using a holographic material having the microscopic physical textures. In various embodiments, creating the mold includes depositing a metal onto the holographic material, where deposition of the metal allows the metal to retain the microscopic physical textures from the holographic material. In various embodiments, the image is of an object or a character. In various embodiments, the microscopic physical textures are configured to interact with light to project a different image dependent upon a relative viewing angle. In various embodiments, the method further includes after applying the mold, allowing the confection to cool or solidify.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore not to be considered limiting of its scope, the disclosure will be described with additional specificity and detail through use of the accompanying drawings.

FIG. 1 is a first view of a confection, according to an example embodiment.

FIG. 2 is a second view of the confection of FIG. 1.

FIG. 3 is a back side of the confection of FIG. 1.

FIG. 4A depicts a portion of a surface of the confection of FIG. 1, according to an example embodiment.

FIG. 4B depicts example holographic foils.

FIG. 5 is a schematic illustration of a method for producing a confection, according to an example embodiment.

FIG. 6 depicts a confection in a first view, according to an example embodiment.

FIG. 7 depicts the confection of FIG. 6 in a second view, according to an example embodiment.

FIG. 8 depicts a confection in a first view, according to an example embodiment.

FIG. 9 depicts the confection of FIG. 8 in a second view, according to an example embodiment.

FIG. 10 depicts a confection in a first view, according to an example embodiment.

FIG. 11 depicts the confection of FIG. 10 in a second view, according to an example embodiment.

FIG. 12 depicts the confection of FIG. 10 in a third view, according to an example embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Described herein are systems and methods for the use of microscopic physical textures for confections. The confection includes the microscopic physical textures on a surface of the confection to create color and/or an illusion of movement, such as shifting color, an animation, an object or a character moving, etc. For example, as described herein, the illusion of movement can be an image appearing to float and move along a surface of the confection. In various embodiments, the image is of an object (e.g., a helicopter) or a character. As light interacts with the microscopic physical textures on the confections, the light is diffracted in a number of directions and angles resulting in a number of different colors being viewed, which can be used to create images. As the view of the confection changes, the way in which the light is viewed to interact with the microscopic physical textures change, resulting in the produced image changing. As a result, a holographic effect is produced on the surface of the confection. The microscopic physical textures can be embossed on the confection by creating a mold having mold microscopic textures. In various embodiments, the mold may be created from a holographic material. The holographic material has the microscopic physical textures on its surface in order to create the holographic effect. The microscopic physical textures from the holographic material can be applied onto the confection through a mold having mold microscopic textures that correspond with the microscopic physical textures from the holographic material. As a result, the microscopic physical textures, and therefore the holographic effect, can be added onto the confection. In various embodiments, the microscopic physical textures added onto the confection have a feature width between 0.00001 millimeters (mm) and 1 mm, inclusive. In various embodiments, the feature width is less than 0.13 mm, inclusive. Advantageously, as the methods and systems described herein are only changing a physical texture of the surface of the confection, the addition of holographic effect on the confection does not require a usage of chemicals or additives. In contrast to approaches that utilize an additional chemical or material added to the confection, the impart of microscopic physical textures is a physical change to the surface of the confection.

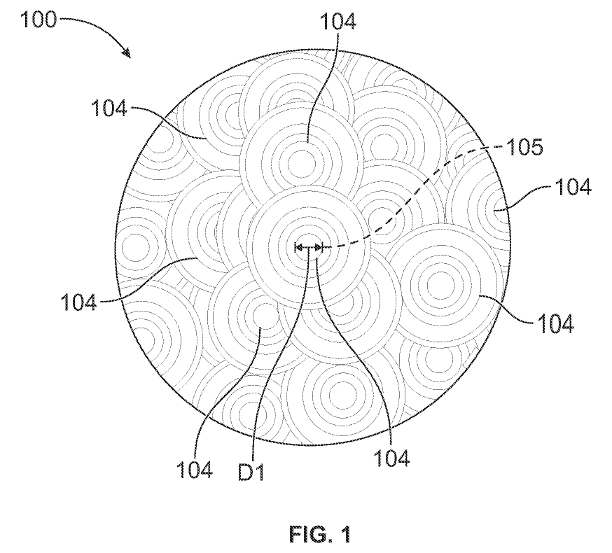

FIG. 1 depicts a confection 100, according to an exemplary embodiment. The confection 100 includes a surface that is able to form the microscopic physical textures, for example the surface comprises an edible material that has a crystalline form. As shown in FIG. 1, the confection 100 may be a chocolate. In various embodiments, the confection 100 is a candy, such as sugar glass, a lollipop, a gummy, isomalt, or caramel. In various embodiments, the confection 100 is a lozenge. In various embodiments, the confection 100 is a part of another edible treat. For example, the confection 100 may be a sugar candy coating for candied apple or a candied window for a gingerbread house. In another example, the confection 100 may be a chocolate or candied pendant positioned on top of another confection 100 (e.g., a cake, a cupcake, a cookie, etc.).

With general reference to the confection, the confection includes microscopic physical textures on a surface of the confection. The microscopic physical textures may be applied onto the confection by a mold. In various embodiments, the microscopic physical textures comprise a plurality of features formed on the surface of the confection. The features may encode a holographic image. In some embodiments the features may be grooves, ridges, or facets. Individual features of the plurality of features will diffract the light, reforming the holographic image light. Because each of the features allow for different angles relative to an observer, the image seen by the observer may vary as their position relative to the confection changes. As light diffracts on the microscopic physical textures, the confection has an appearance of movement. As described herein, the movement may include a change in color, a change in shape, movement of an object, among others, in combination or individually. The perceived movement occurs as the confection and/or a consumer perceiving the confection moves. The confection having a glossy and/or shiny appearance aids in the illusion of movement occurring. The glossy surface absorbs less light, resulting in more effective reflection and diffraction, enhancing the illusion of movement as the holographic patterns and colors appear clearer. The systems and methods, described herein is a physical addition to the confection, allowing for movement to be perceived on the confection without additives or dyes.

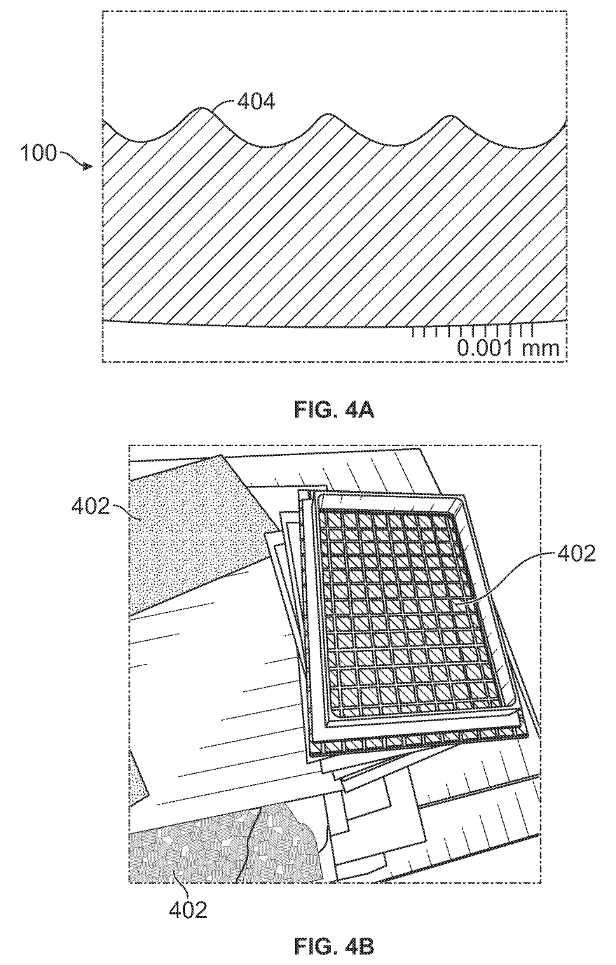

The confection 100 of FIG. 1 depicts a chocolate candy. As shown in FIG. 1, the confection 100 includes an appearance of a pattern, shown as circular rings 104. The circular rings 104 are multicolored (e.g., rainbow-colored), such that there are a number of colors in each of the circular rings 104. In various embodiments, the circular rings 104 may not be multicolored, such that a specific color (e.g., white) is perceived on, or above, a surface of the confection 100. The appearance of the circular rings 104 is caused by microscopic physical textures on the surface of the confection 100. FIG. 4A depicts a portion of the surface of the confection 100, according to an example embodiment. The portion of the surface includes microscopic physical textures, shown as grooves 404. The interaction of light on the grooves 404, as described herein, cause the perception of the pattern, which in this example embodiment, is the circular rings 104. The microscopic physical textures give the surface of the confection 100 a holographic appearance, such that motion is perceived by a consumer of the confection 100. The glossy surface of the confection 100 aids in the holographic appearance of the confection 100.

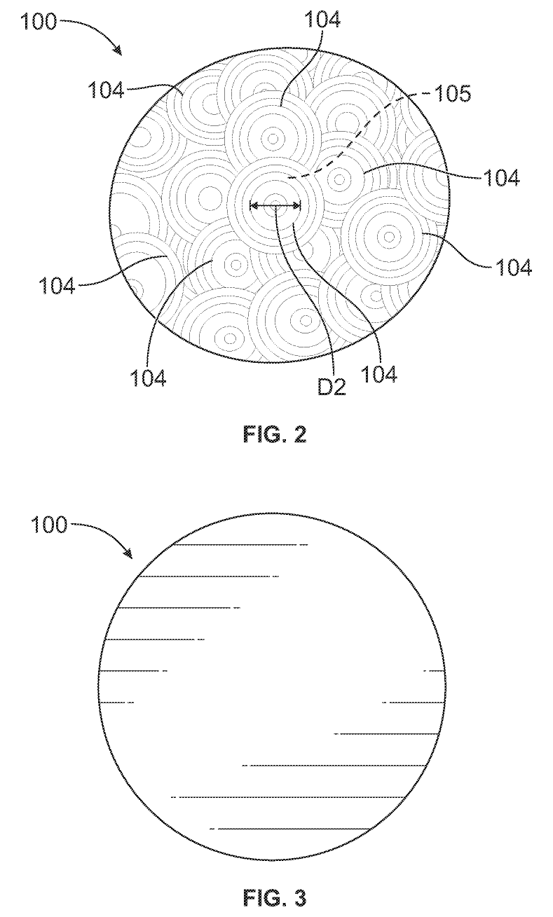

As a result, as light hits the microscopic physical textures, an observer sees colors based on the pattern as encoded from an initial hologram. In other words, the surface of the confection 100, based on a view of the material, is perceived to have different colors and effects. As the view changes (e.g. the confection 100 moves, an observer moves, etc.), how the light hits the microscopic physical texture changes, therefore changing how the resultant image from the confection 100 is perceived. For example, in a first view, the confection 100 may be perceived as having a plurality of rings (e.g., single colored or multicolored rings) and in the second view, as an observer viewing the confection 100 moves, the plurality of rings may appear to expand and/or contract, creating an illusion of movement. FIG. 1 shows the confection 100 in a first view. In the first view, the circular ring 104 in position 105 has a first diameter D1. As a perspective of the confection 100 changes, as shown in FIG. 2 of the confection 100 in a second view, the circular rings 104 appear to change shape (e.g., expand or contract). In the second view shown in FIG. 2, the circular ring 104 in position 105 has a second diameter D2 that is larger than the first diameter D1.

The microscopic physical textures may be received by holographic materials, as described herein. FIG. 4B shows holographic materials 402. The holographic materials 402 have microscopic physical textures that include a number of different angles and sizes. The usage of microscopic physical textures in holographic materials 402 along with light creates an illusion of colors and the microscopic physical textures can be manipulated to create a specific imagery or motion, as described herein. By applying the microscopic physical textures from holographic materials 402 onto a confection, the illusion from the holographic material 402 can be perceived on the confection. In various embodiments, the holographic materials 402 of FIG. 4B may be created by recording a holographic image onto a photosensitive material with lasers. Such recordation can allow for detailed and precise images to be created using laser technology. The lasers on the photosensitive material create the patterns with microscopic physical textures, such as peak and valleys with varying angles. In various embodiments, the holographic material may be a polyester film. For example, the polyester film may be biaxially-oriented polyethylene terephthalate (BoPET). The polyester film includes the microscopic physical textures that give the film an appearance of movement and color as the film or an observer’s view of the film changes.

In various embodiments, the pattern (e.g., a design, a vector art design, etc.) for the holographic material 402 is digitally created and exported at a point per inch (PPI). In various embodiments, the PPI may be between 72 and 600, inclusive. A higher PPI may result in high resolution for preparing (e.g., transferring, printing, etc.) the pattern onto the holographic material 402. The pattern is related to features (e.g., grooves, ridges, etc.) for the holographic material 402, with light interacting with the applied features resulting in colors and patterns being viewed, as described herein. The pattern can be applied to a material to create the holographic material 402 (e.g., using laser technology). In various embodiments, the holographic material 402 has a resolution between 13500 lines per inch (LPI) and 72 LPI, inclusive. A higher LPI relates to an increased frequency of the features on the holographic material 402 and a higher resolution.

In various embodiments, the microscopic physical textures on the confection 100 are physically embossed, molded, or otherwise formed on the confection 100. A surface of the confection 100 is manipulated and changed to add the microscopic physical textures. For example, the confection may comprise an edible material, e.g. chocolate or sugar, and the microscopic physical textures may consist or consist essentially of the same edible material. The appearance of an image, such as the circular rings 104 of FIG. 1, using the microscopic physical textures does not require dyes, chemicals, or pigments. As a result, there is no residue from the microscopic physical textures as a consumer eats the confection 100 or interacts with the confection 100.

In various embodiments, the microscopic physical textures may only be added on a first side of the confection 100. In other embodiments, different microscopic physical textures may be applied to different sides of a confection. For example, a top side surface may have a microscopic physical texture (or set of microscopic physical textures) corresponding to a first hologram or image and a side surface, such as a circumference of a cake, may have a second microscopic physical texture (or second set of microscopic physical textures) corresponding to a second hologram or image. For example, the first hologram may be of a spaceship and the second hologram maybe be an image including the spaceship and conveying movement of the spaceship as the cake is rotated. FIG. 3 shows a back side surface of the confection 100. As shown in FIG. 3, the back side surface of the confection 100 includes no microscopic physical textures that interact with light. As such, the appearance of the back side surface appears as the confection would typically be observed, with no change in color or movement of objects. In various embodiments, the front side surface and the back side surface include the microscopic physical textures. In various embodiments, a surface within the confection 100 may include the microscopic physical textures. For example, a consumer of the confection 100 may bite into, break, open, or remove a layer on the confection 100 to reveal the microscopic physical textures that produce a holographic effect. In one embodiment, microscopic physical textures may be formed on a surface of the confection with a greater rigidity and/or hardness than other portions of the confection, such as an outer or external surface, for example a low melting point chocolate outer surface where the microscopic physical textures are formed on a sugar glass surface beneath.

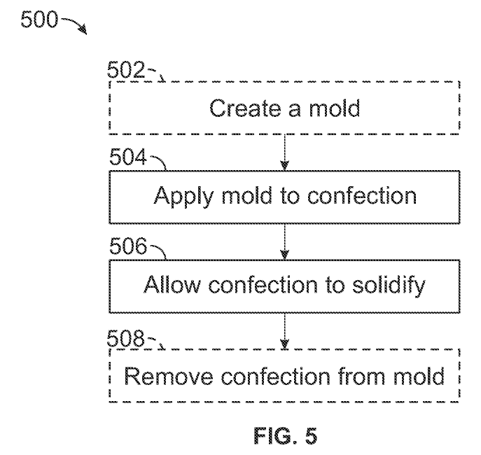

FIG. 5 shows a method 500 of producing a confection, according to an example embodiment. In various embodiments, the confection referred to by method 500 is the confection 100 described with reference to FIG. 1, and method 500 may be implemented to produce the confection 100.

As shown in FIG. 5, method 500 includes creating a mold at step 502. The mold is of a material with microscopic physical textures. For example, the mold may be of a holographic material (e.g., holographic foil). As described herein with reference to FIG. 4B, the holographic material 402 has microscopic physical textures. As light diffracts off the surfaces of these microscopic physical textures, an illusion of colors is created. By creating a mold of these microscopic physical textures, the microscopic physical textures that create the illusion of color on the holographic material 402 can be added to the confection (e.g., confection 100) through the mold. In various embodiments, step 502 may include creating the holographic material with microscopic physical textures. As described herein with reference to FIG. 4B, the holographic material 402 can be created by recording a holographic image onto a material (e.g., a photoresist material) with lasers. The usage of lasers on the material create patterns with microscopic physical textures. In various embodiments, the holographic image recorded may be an object, a character, and/or include custom features that are digitally designed. In various embodiments, the material with microscopic physical textures may be arranged (e.g., cut, collaged, etc.) to form shapes or images to create a mold of. As a result, the mold may be of the material in a certain arrangement to form a specific shape or image.

The mold includes a surface for applying the microscopic physical textures from the material to the confection. The surface of the mold includes mold microscopic textures formed by the material that correspond to the microscopic physical textures of the material due to the process of creating the mold. In various embodiments, the mold microscopic textures correspond to a negative of the microscopic physical textures. In such embodiments, the mold has a negative relief, and the mold microscopic textures are recessed inwards into the surface. In various embodiments, the mold microscopic textures may correspond with a positive of the microscopic physical textures. In such embodiments, the mold has a positive relief, and the mold microscopic textures are protruding outward from the surface.

In various embodiments, the mold is created with silicone. For example, the mold may be created with food-grade silicone to ensure that application of the mold onto the confection (e.g., with reference to step 504 of method 500) does not transfer toxic materials onto the confection. Silicone molds with microscopic physical textures can be created by pouring silicone on a material with microscopic physical textures (e.g., holographic foil). The microscopic physical textures from the material can be captured by the silicone, such that the created silicone mold includes the microscopic physical textures of the material. Other materials may be used to create the mold, such as liquid rubbers, among other molding materials. Advantageously, the silicone mold does not damage the material with microscopic physical textures, allowing for the material to be reusable to create additional molds.

In various embodiments, the mold is a master roller. For example, the mold may be a holographic master roller. The master roller can be manufactured by depositing a metal (e.g., aluminum, nickel, silver, etc.) onto a material containing microscopic physical textures to form the master roller. The deposition of the metal allows for the metal to retain the microscopic physical textures from the material. The mold with the metal can be used in creating the confection. Advantageously, the use of a master roller in creating the confection may allow for industrial and/or large scale production of the confection. The master roller may have a longer longevity and higher quality than mold created with silicone. Additionally, the mold may be created through scratch holograms. A material (e.g., a metal, plastic, etc.) can be scratched (e.g., by a pin, sharp needle, stylus, etc.) to create images. The scratching of the material creates microscopic physical textures that produce a holographic effect with light. The usage of scratch holograms offers a precise way to create specific images and patterns on the mold.

A shape of the mold may have a variety of shapes. The shape of the mold may be dependent on the desired confection. For example, the pattern on the mold may be along a plane to stamp a flat surface (e.g., a chocolate candy as shown in FIG. 1). In another example the pattern on the mold may be spherical or three-dimensional to stamp a round/three-dimensional surface. For example, the pattern may be used for stamping sugar candy on candied apples. Generally, the holographic material for creating the mold can be easily manipulated and adjusted to create a desired shape when creating the mold at step 502. In various embodiments, the molds created at step 502 are reusable, such that the same mold can be used on a number of confections allowing for repeatability of the process with the mold. Thus, the process of forming a confection with a microscopic physical textures may begin with use of a pre-made mold and proceed to applying the form to the confection (i.e., step 502 is optional and may be omitted).

Method 500 includes applying the mold to the confection at step 504. In various embodiments, the confection may be stamped or casted with the mold created at step 502. For example, the confection may be poured into the mold to form the confection with microscopic physical textures on a surface of the confection. As described herein, a glossy surface of the confection aids in the illusion of color produced by the microscopic physical textures. For example, in embodiments, where the confection is chocolate, it may be advantageous to obtain Form V chocolate (e.g., by tempering) for applying the mold, as Form V chocolate has a shiny appearance. Other confections such as gummies, sugar glass, and isomalt have a shiny/glossy appearance that enhances the reflection of light and therefore enhances the illusion of movement and/or color when applying the mold. In various embodiments, additional materials (e.g., a glaze, fats, oils, etc.) may be added to the confection to enhance the glossy appearance of the confection and improve the illusion of the holographic effect. For example, the confection may be a fondant, and a glaze may be added to the fondant before or after stamping the fondant with the mold to give the fondant a shiny appearance and enhance the holographic effect on the fondant.

At step 504, the mold is applied to the confection while the confection is in a melted and/or viscous state (e.g., a hot and/or a liquid mixture). For example, the confection may be melted (e.g., with a microwave, a stove, etc.), heated, torched, boiled (e.g., with a vacuum boiler), etc., such that the confection can be molded. The confection may have viscoelastic properties at step 504.

Method 500 includes allowing the confection to solidify at step 506. Solidification of the confection at step 506 may include complete solidification, partial solidification, hardening, and/or cooling. For example, when tempering chocolate to imbue the chocolate with the microscopic physical texture at step 504, step 506 may include allowing the chocolate to cool and solidify. Once solidified at step 506, the confection includes microscopic physical textures that produce holographic effects as light reflects on the microscopic physical textures. In various embodiments, method 500 includes removing the confection from the mold at step 508. The confection may be removed from the mold after the mold has solidified at step 506. For example, the confection may be separated (e.g., by peeling the mold) from the mold to create the confection with the microscopic physical textures.

In various embodiments, step 506 may also include vacuum sealing the confection (e.g., putting the confection in a packaging). Advantageously, vacuum sealing the confection may allow for the microscopic physical textures to stay on the confection longer, which prolongs a duration of the holographic effect. Additionally, the duration of the holographic effect may be dependent on the confection. Certain types of confections may be more susceptible to change. For example, chocolate may be less stable than a gummy in terms of sensitivity to temperature changes. As the systems and methods described herein are microscopic physical textures on the confection, as the confection changes, the microscopic physical textures change, which may result in a loss or reduction of the holographic effect.

In various embodiments, the confection may be placed in a space with controlled lights. By controlling the lights and therefore controlling how the light reflects on the confection, the holographic pattern on the confection can be controlled. This may be used to animate colors and moving patterns in a specific sequence. For example, the space that the confection is placed in may be a display case. The display case may include LED lights (e.g., moving LED lights, stationary LED lights, strip LED lights) that reflect on the confection in a sequence, allowing the holographic pattern to be perceived in a specific way. For example, the LED lights may move to change to animate the holographic pattern. In another example, an intensity of the lights may be changed or the wavelength of light projected onto the confection may be in a particular pattern.

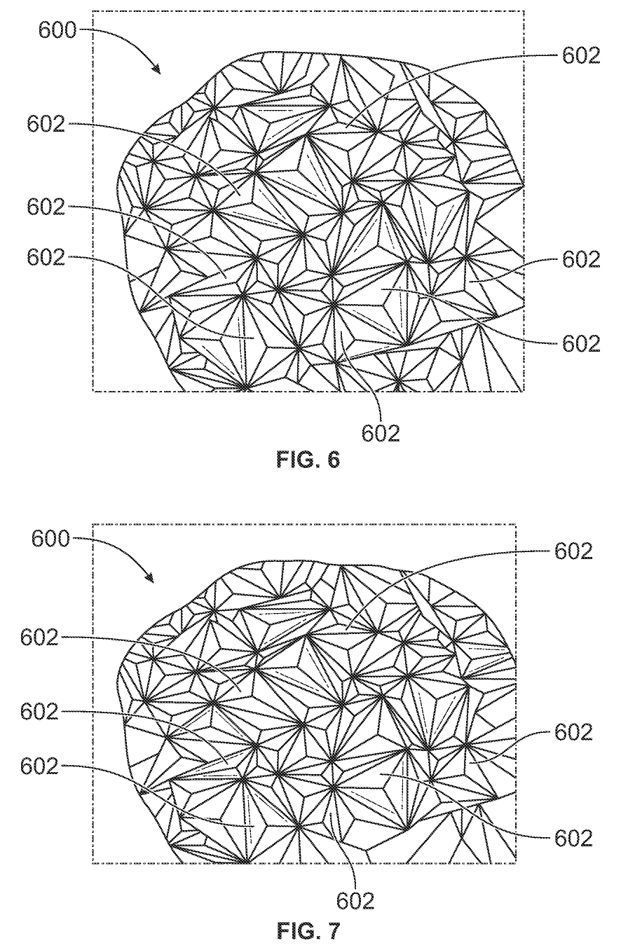

FIGS. 6 and 7 depict a confection 600 in a first view (FIG. 6) and a second view (FIG. 7). The confection 600 is a chocolate. The confection 600 has a surface that includes a number of holographic patterns. As described herein with reference to method 500, the holographic patterns on the confection 600 are formed by stamping the confection 600 with a mold that has mold microscopic textures. The holographic pattern of the confection 600 depends on the holographic pattern of the material used to create the mold. In the illustrated embodiment, the pattern of the confection 600 includes a plurality of triangles 602 of different shapes, and sizes forming edges and vertices. As shown in FIGS. 6 and 7, as the view of the confection 600 changes (e.g., from the first view to the second view), a perception of the triangles 602 changes. Although not illustrated, in addition or alternatively, as the view of the confection 600 changes (e.g., from the first view to the second view), a color of one or more of the triangles 602 changes. As a result, the holographic patterns on the confection 600 can create an illusion of multiple three-dimensional pyramids changing shape or position, and additionally or alternatively, the colors of the triangles 602 may change. Through use of the microscopic physical textures on the confection 600, the confection 600 can appear to have three-dimensional shapes due to the diffractions and reflections of light on the microscopic physical textures.

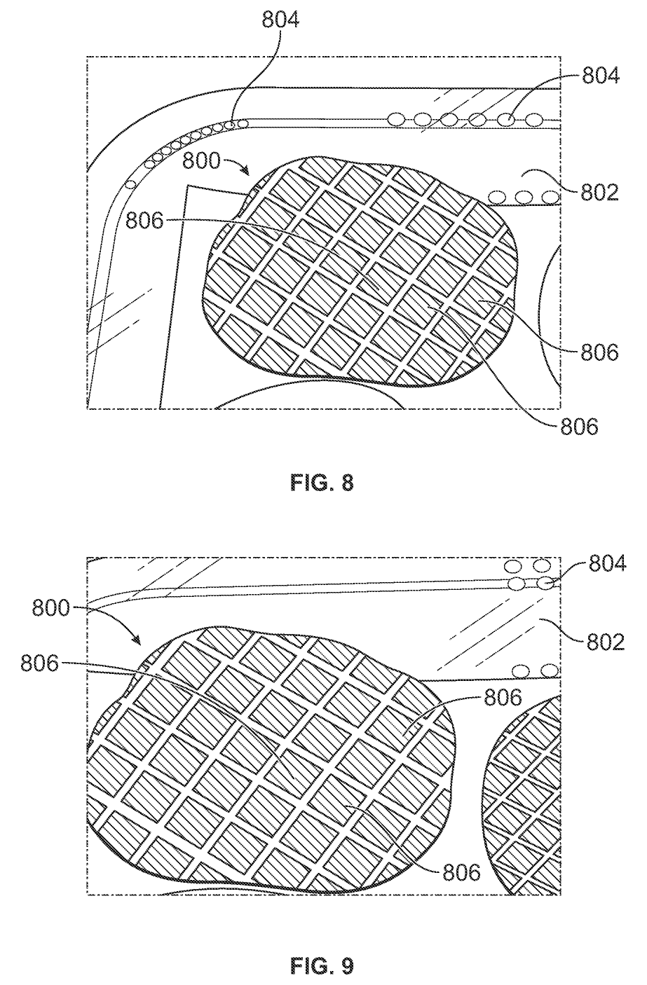

FIGS. 8 and 9 depict a confection 800 in a first view (FIG. 8) and a second view (FIG. 9). As shown in FIGS. 8 and 9, the confection 800 is positioned within a display case 802. The display case 802 includes lights 804 within the display case 802. The confection 800 includes microscopic physical textures, that cause holographic patterns 806 to appear on the confection 800. The lights 804 may be operated (e.g., turned on or off) in a sequence or pattern such that the light “moves” and animates the holographic patterns 806. As a result, the patterns appear to be changing colors and animating. As shown in FIG. 8, in the first view, the lights 804 near the confection 800 are “ON” and in the second view shown in FIG. 9, the lights 804 further from the confection 800 are “ON”. As a result, an image and color created from the holographic patterns 806 changes between the first view and the second view. Advantageously, the addition of the lights 804 creates more movement and motion from the holographic patterns 806 on the confection 800.

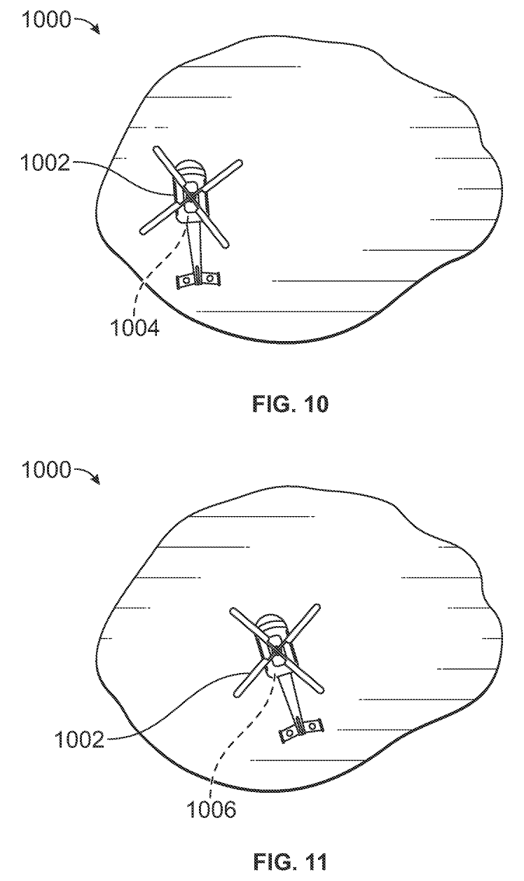

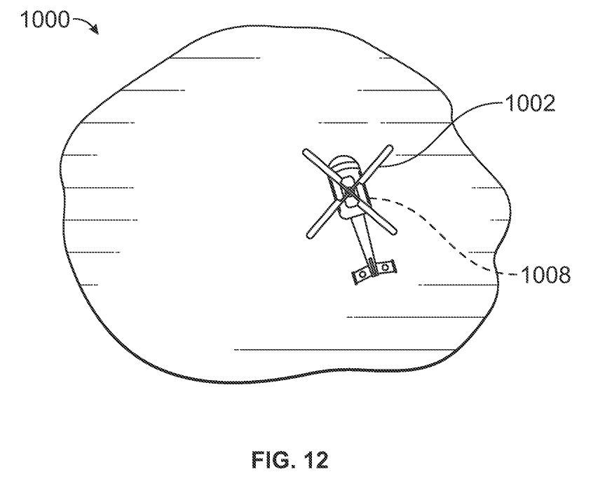

FIGS. 10-12 depict a confection 1000 in a first view (FIG. 10), a second view (FIG. 11), and a third view (FIG. 12). The confection 1000 includes microscopic physical textures, that create an image with reflection of light on the microscopic physical textures. The image created is shown as helicopter 1002. By precisely designing the microscopic physical textures for the confection 1000 (e.g., through scratch holograms, by creating the material for the mold, etc.), a specific image can be shown on the confection 1000. As shown in FIGS. 10-12, the formed image is a representation of an object. For example, the spaceship on the confection 1000 appears to float on a surface of the confection 1000 through use of the microscopic physical textures on the surface. In the first view, the helicopter 1002 is at a first position 1004 on the confection 1000. The first position 1004 is dependent on how light reflects off the microscopic physical textures on the surface of the confection 1000. As a view of the confection 1000 changes, a position of the helicopter 1002 changes. In the second view which is a different view from the first view, the way in which the light is perceived to reflect the microscopic physical textures changes resulting in the position of the helicopter 1002 to change to a second position 1006. Additionally, an angle of the helicopter 1002 changes, such that as the helicopter 1002 moves from the first position 1004 to the second position 1006 it appears to be floating or flying on the confection 1000. This movement is further shown in the third view as the helicopter 1002 moves from the second position 1006 to a third position 1008. Through designing the microscopic physical textures, specific images and movements can be created on the confection.

While this specification contains specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

It is important to note that the construction and arrangement of the various systems shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

What is claimed is:

1. A confection, comprising:
microscopic physical textures on a surface of the confection, the microscopic physical textures encoding a hologram;
the microscopic physical textures configured to interact with light to form an image based on the encoded hologram.

2. The confection of claim 1, wherein the formed image includes at least one of color, movement, or a change in a shape.

3. The confection of claim 1, wherein the confection is a sugar glass, a chocolate, a gummy candy, or a lozenge.

4. The confection of claim 1, wherein the encoded hologram is a representation of an object or a character.

5. The confection of claim 4, wherein the object or the character is perceived to be in a first position relative to the surface at a first view of the confection and the object or the character is perceived to be in a second position relative to the surface at a second view of the confection, the first position being different than the second position.

6. The confection of claim 1, wherein the surface is an external surface of the confection.

7. The confection of claim 1, wherein the confection includes second microscopic physical textures encoding a second hologram on a second surface of the confection and the second microscopic physical textures are configured to interact with the light to form a second image based on the second encoded hologram.

8. The confection of claim 1, wherein the surface of the confection has a glossy appearance.

9. The confection of claim 1, wherein the surface of the confection is three-dimensional.

10. The confection of claim 1, wherein the light on the microscopic physical textures is controlled by controlling an operation or an intensity of the light.

11. A mold for use on a confection, comprising:
a surface having mold microscopic textures formed by a holographic material comprising microscopic physical textures, wherein the mold microscopic textures correspond to the microscopic physical textures;
wherein the mold is configured to apply the microscopic physical textures from the holographic material to the confection.

12. The mold of claim 11, wherein the mold is configured to be stamped on the confection.

13. The mold of claim 11, wherein the mold microscopic textures are formed through a needle configured to scratch the surface of the mold.

14. The mold of claim 11, wherein the mold microscopic textures correspond to a negative of the microscopic physical textures.

15. A method for producing a confection, comprising:
applying a mold to the confection; and
forming microscopic physical textures on a surface of the confection, the microscopic physical textures encoding a hologram such that interaction of light with the microscopic physical textures allow for perception of an image.

16. The method of claim 15, further comprising before applying the mold to the confection, creating the mold using a holographic material having the microscopic physical textures.

17. The method of claim 16, wherein creating the mold comprises depositing a metal onto the holographic material, deposition of the metal configured to allow the metal to retain the microscopic physical textures from the holographic material.

18. The method of claim 15, wherein the image is of an object or a character.

19. The method of claim 15, wherein the microscopic physical textures are configured to interact with light to project a different image dependent upon a relative viewing angle.

20. The method of claim 15, further comprising, after applying the mold, allowing the confection to cool or solidify.
